(19) United States
(12) Patent Application Publication
(10) Pub. No.: US 2012/0174938 A1
(43) Pub. Date: Jul. 12, 2012

(54) ROTATING TOOTHBRUSH

(76) Inventor: Kris Hill, Sydney (AU)

(21) Appl. No.: 13/344,582

(22) Filed: Jan. 5, 2012

(30) Foreign Application Priority Data
Jan. 6, 2011 (AU) 2011900030

(51) Int. Cl. A46B 9/04; B08B 1/04; A46B 13/02

(52) U.S. Cl. 132/200; 15/22.1

(57) ABSTRACT

An electric toothbrush contains a plurality of bristles attached to a bristle carrier which rotates 360 degrees continuously. The electric toothbrush can assist in the correct brushing of teeth in humans. The electric toothbrush includes reloadable batteries with reverse polarity and an electric motor which connects to the bristle holder, wherein actuation of an activating means causes the bristle holder to rotate 360 degrees continuously.

### CROSS-REFERENCE TO RELATED APPLICATIONS

The present invention claims the benefit of priority of Australian Provisional patent application number 2011900030, filed Jan. 6, 2011, which is herein incorporated by reference.

### BACKGROUND OF THE INVENTION

The present invention relates to the field of toothbrushes, and more particularly, to electrically powered rotating toothbrushes.

Most known electric toothbrushes utilize a single bristle carrier that is powered or otherwise driven by an electric motor incorporated in the toothbrush. The bristle carriers in these toothbrushes undergo a wide array of motions. For example, bristle carriers undergoing rotary motion are well known. Bristle carriers that reciprocate in a linear fashion within the plane of the brush are also known. In addition, bristle carriers that reciprocate in a linear fashion perpendicular to the plane of the brush are also known.

Many attempts have been made to improve the design, efficiency, cleaning efficacy, simplicity, and/or commercial viability of electric toothbrushes. One approach has been to provide multiple powered bristle carriers. Most electric toothbrushes have grouped multiple sets of bristles along an end of a brush and incorporate a drive mechanism for simultaneously rotating each of the bristle sets, together.

However, these types of brushes also have limited cleaning efficiency as well as being harsh on the gums. Brushes that rely on rotational linear movement of the bristles irritate the gums and uncover the dental neck of a tooth.

As can be seen, there is a need for an electric toothbrush that moves bristles away from the gums so as to avoid attacking the gum line.

### SUMMARY OF THE INVENTION

According to one aspect of the present invention, the present invention may substantially overcome or at least ameliorate one or more of the above disadvantages, or at least provide a useful alternative. Embodiments of the present invention may (a) provide an electric toothbrush that brushes teeth correctly; (b) provide an electric toothbrush that brushes teeth in a way which is harmless to the gums, that is, without hitting or attacking the gums; (c) provide an electric toothbrush with 360 degree continuous rotating bristles; (d) provide an electric toothbrush that, when activated, will spin away from the gums; (e) provide an electric toothbrush with forward and reversible operation on rotation of the bristles; (f) provide an electric toothbrush which can clean teeth effectively, irrespective of which hand it is held; (g) provide an electric toothbrush which contains at least one battery that has a reverse polarity which allows the bristles to spin forward and in reverse; and (h) provide an electric toothbrush that is capable of always brushing away from the gums and in between the teeth in the same direction that teeth grow in.

In one aspect of the present invention, an electric toothbrush comprises handle; a head integrally connect with the head; a brush holder containing a plurality of bristle tufts, the brush holder engaging with the head; an electric motor mechanically connected to the brush holder, the electric motor adapted to continuously rotate the brush holder; and a power supply adapted to power the electric motor.

In another aspect of the present invention, an electric toothbrush comprises a handle; an electric motor housed in the handle; a shaft mechanically connecting the electric motor with a bristle carrier, wherein rotation of the electric motor causes rotation of the bristle carrier; a plurality of bristles disposed about the bristle head; and a switch for providing either a first polarity of power to the electric motor or a second, opposite polarity of power to the electric motor, the first polarity of power causing the bristle head to rotate in a first direction and the second polarity of power causing the bristle head to rotate in a second, opposite direction

In still another aspect of the present invention a method for brushing teeth comprises applying continuously rotating bristles against a user's teeth, wherein the bristles rotate in a direction away from a gum line of the user, wherein the bristles are part of an electric toothbrush, the electric toothbrush comprising a handle; a head integrally connect with the head; a brush holder containing the rotating bristles, the brush holder engaging with the head; an electric motor mechanically connected to the brush holder, the electric motor adapted to continuously rotate the brush holder; and a power supply adapted to power the electric motor.

These and other features, aspects and advantages of the present invention will become better understood with reference to the following drawings, description and claims.

### BRIEF DESCRIPTION OF THE DRAWINGS

FIG. 1 is a front view of an electric toothbrush according to an exemplary embodiment of the present invention;

FIG. 2 is a left side view of the electric toothbrush of FIG. 1;

FIG. 3 is a right side view of the electric toothbrush of FIG. 1;

FIG. 4 is a top view of the electric toothbrush of FIG. 1;

FIG. 5 is a back view of the electric toothbrush of FIG. 1;

FIG. 6 is a front view of the electric toothbrush of FIG. 1;

FIG. 7 is a cross sectional view taken along line 7-7 of FIG. 1; and

FIG. 8 is an exploded view of the electric toothbrush of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides an electric toothbrush that contains a plurality of bristles attached to a bristle carrier which rotates 360 degrees continuously. The electric toothbrush can assist in the correct brushing of teeth in humans. The electric toothbrush includes reloadable batteries with reverse polarity and an electric motor which connects to the bristle holder, wherein actuation of an activating means causes the bristle holder to rotate 360 degrees continuously.

Embodiments of the present invention provides an electric toothbrush which cleans teeth correctly, that is, by always brushing away from the gums, irrespective of whether the person using the brush is right or left handed. Embodiments of the present invention make brushing quicker and more efficient. The electric toothbrush may even allow for people that are sick or disabled, or children, to brush their teeth correctly without the need of manual skill and effort. The electric toothbrush according to embodiments of the present invention may also contain removable and replaceable bristles.

Further, embodiments of the present invention may include an electric toothbrush construction that permits the bristles of the toothbrush to always brush teeth away from the gums.

The present invention meets the need in the art by providing an electric toothbrush that avoids the problem of very repetitive micro-impacts caused by the toothbrush bristle tips on the gum line. The toothbrush of the present invention may utilize 360 degree continuous rotation and may require a cylindrical brush head. The brush head may be adapted to engage with the handle of the toothbrush. The back of the brush head may also contain a number of grooves or ribs which act as a tongue scraper to further assist in the oral hygiene of the user.

The brush head comprises a brush holder or carrier which includes a plurality of bristles. The brush head may be integrally connected to the handle whereupon an activating means which powers the brush holder, driving its 360 degree rotation around the brush holder's longitudinal axis. The activation means is essentially an on/off switch/button, operated manually when the switch is flicked. Moving the switch down moves the brush holder counter-clockwise (when viewed from the top) for cleaning the bottom teeth (with one's right hand), while moving the switch up moves the brush holder clockwise (when viewed from the top) for cleaning the top teeth (with one's right hand).

The power cell, typically an AAA battery, may be held within a pressed metal compartment or an injection-molded plastic compartment in a bottom end of the toothbrush, where at least one electric motor may be arranged.

The toothbrush of the present invention may be substantially constructed of plastic, with the bristles being constructed of nylon. Other materials, as may be known in the art, may be used for the various components. The toothbrush body may be designed to include the electric motor and other components which are encased so as not to interfere with the user.

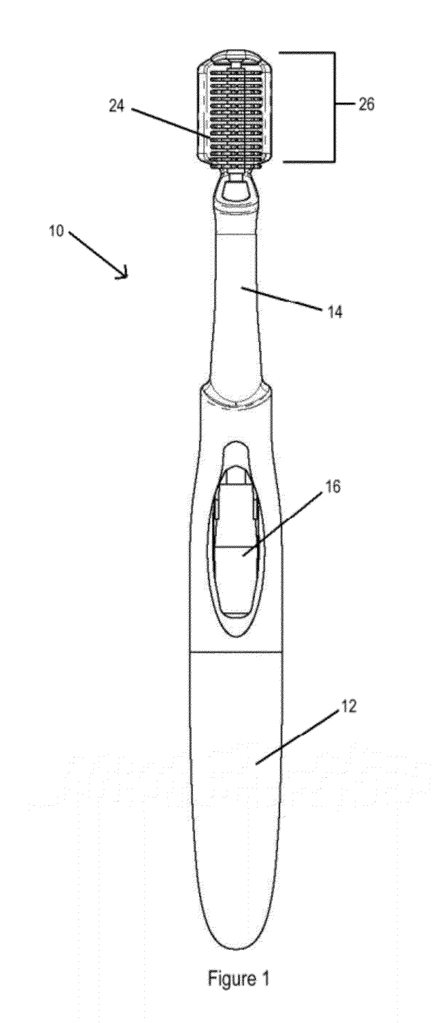

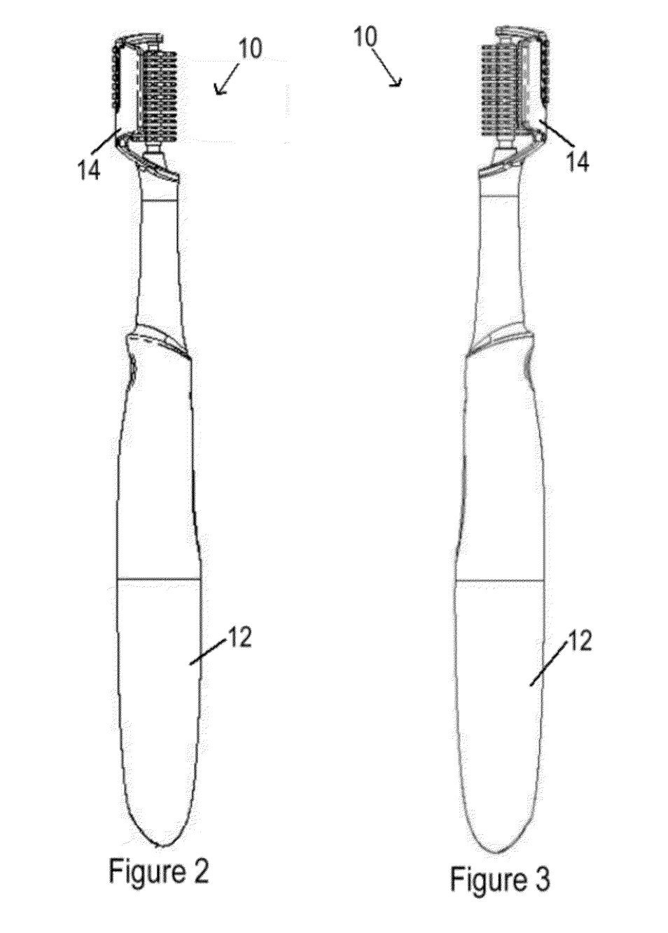

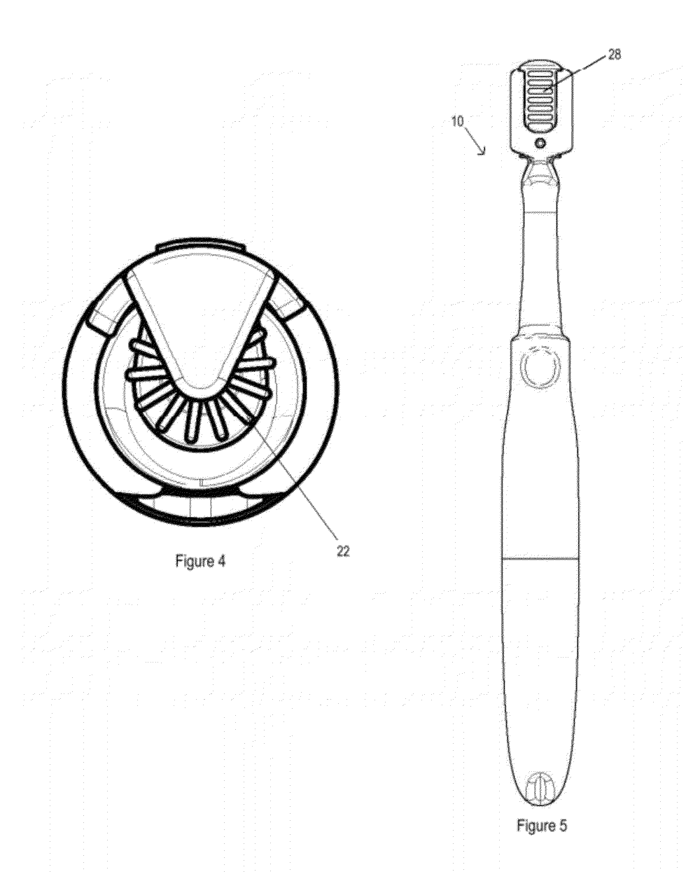

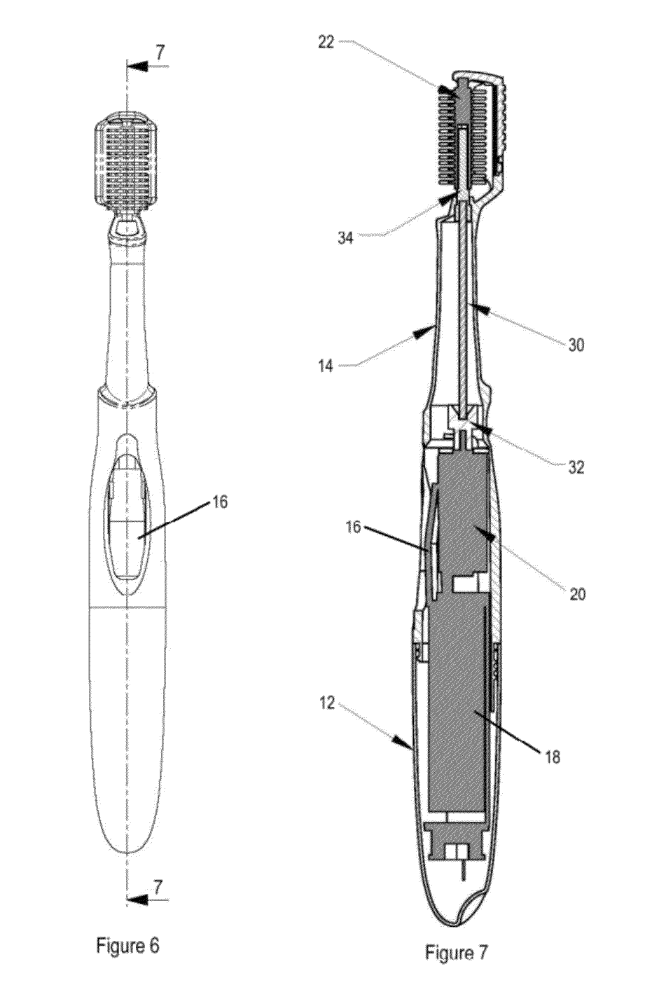

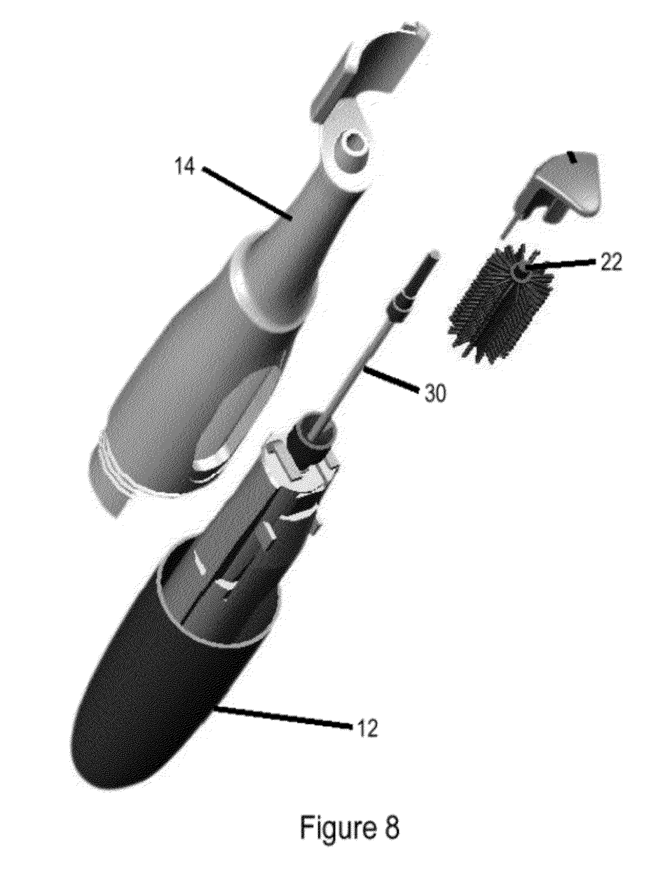

Referring now to FIGS. 1 through 8, an electric toothbrush 10 may have a handle 12 and a head 14. The handle 12 may include, there within, an electric motor 20 adapted to drive rotation of a brush 26 via a shaft 30. The shaft 30 may be connected to the motor via a shaft-motor connector 32. The other end of the shaft may be connected to the brush 26 by a connector 34.

The handle 12 may be integrally connected to the head 14. The handle 12 may include an activating means 16. Batteries 18 may power the electric motor 20. The batteries 18 may be housed within the handle. The batteries may be various shapes and sizes. For example, the batteries 18 may be a single AAA battery, a plurality of button batteries, or the like.

The head 14 may be adapted to engage with a bristle carrier 22. The bristle carrier 22 may hold all the bristles 24 of the brush 26. The back of the head 14 may include a plurality of grooves 28. The grooves 28 may be useful as a tongue scraper, for example.

In the embodiment shown in the figures, the electric toothbrush 10 is generally cylindrical. However, it will be appreciated that the electric toothbrush 10 may be made in other suitable shapes.

It should be understood, of course, that the foregoing relates to exemplary embodiments of the invention and that modifications may be made without departing from the spirit and scope of the invention as set forth in the following claims.

What is claimed is:

1. An electric toothbrush comprising:
a handle;
a head integrally connect with the head;
a brush holder containing a plurality of bristle tufts, the brush holder engaging with the head;
an electric motor mechanically connected to the brush holder, the electric motor adapted to continuously rotate the brush holder; and
a power supply adapted to power the electric motor.

2. The electric toothbrush of claim 1, further comprising a shaft interconnecting the electric motor with the brush holder.

3. The electric toothbrush of claim 2, further comprising a shaft-motor connector adapted to connect the electric motor with the shaft.

4. The electric toothbrush of claim 1, further comprising a plurality of grooves on a back side of the head.

5. The electric toothbrush of claim 1, wherein the electric motor and the power supply are housed within the handle.

6. The electric toothbrush of claim 1, wherein the power supply is includes one or more batteries.

7. The electric toothbrush of claim 1, further comprising activation means for electrically connecting the power supply with the electric motor.

8. The electric toothbrush of claim 7, wherein the activation means includes an on/off switch/button.

9. The electric toothbrush of claim 8, wherein the activation means include a first position, supplying a first polarity of power to the electric motor, and a second position, supplying a second, opposite polarity of power to the electric motor.

10. An electric toothbrush comprising:
a handle;
an electric motor housed in the handle;
a shaft mechanically connecting the electric motor with a bristle carrier, wherein rotation of the electric motor causes rotation of the bristle carrier;
a plurality of bristles disposed about the bristle head; and
a switch for providing either a first polarity of power to the electric motor or a second, opposite polarity of power to the electric motor, the first polarity of power causing the bristle head to rotate in a first direction and the second polarity of power causing the bristle head to rotate in a second, opposite direction.

11. The electric toothbrush of claim 10, further comprising a shaft-motor connector adapted to connect the electric motor with the shaft.

12. The electric toothbrush of claim 10, further comprising a plurality of grooves on a back side of the head.

13. The electric toothbrush of claim 10, further comprising a power supply housed within the handle.

14. The electric toothbrush of claim 13, wherein the power supply includes one or more batteries.

15. A method for brushing teeth comprising:
applying continuously rotating bristles against a user's teeth, wherein the bristles rotate in a direction away from a gum line of the user, wherein the bristles are part of an electric toothbrush, the electric toothbrush comprising a handle; a head integrally connect with the head; a brush holder containing the rotating bristles, the brush holder engaging with the head; an electric motor mechanically connected to the brush holder, the electric motor adapted to continuously rotate the brush holder; and a power supply adapted to power the electric motor.
